(19) United States
(12) Patent Application Publication
(10) Pub. No.: US 2008/0170867 A1
(43) Pub. Date: Jul. 17, 2008

(54) IMAGE FORMING APPARATUS AND POWER SUPPLYING METHOD THEREOF

(75) Inventors: Myung-kook AHN, Suwon-si (KR); Hyou-jin Kim, Anyang-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/942,947

(22) Filed: Nov. 20, 2007

(30) Foreign Application Priority Data
Jan. 12, 2007 (KR) 2007-3928

(51) Int. Cl. G03G 15/00; G03G 15/02; G03G 15/16; G03G 21/00

(52) U.S. Cl. 399/13; 399/50; 399/128; 399/48; 399/66; 399/88; 399/89

(57) ABSTRACT

An image forming apparatus includes an image forming part that forms an image on a recording medium and includes a plurality of photoconductors, a plurality of charging parts that charges the photoconductors, a plurality of developing parts that develops the charged photoconductors, and a plurality of static electricity erasing parts that erases surface potentials of the charged photoconductors. A power supplying part supplies power to the image forming part, and a controller controls to switch the operation of the static electricity erasing parts independently and controls the image forming part to form the image on the recording medium if power applied to the respective photoconductors through the charging parts and the developing parts reaches a target value.

### CROSS-REFERENCE TO RELATED APPLICATIONS

This application claims priority from Korean Patent Application No. 10-2007-0003928, filed on Jan. 12, 2007 in the Korean Intellectual Property Office, the disclosure of which is incorporated herein by reference.

### BACKGROUND OF THE INVENTION

1. Field of the Invention

The present general inventive concept relates to an image forming apparatus and a power supplying method thereof, and more particularly, to an image forming apparatus that detects power applied to a photoconductor and supplies charging power and developing power based on the detected power, and a power supplying method thereof.

2. Description of the Related Art

An image forming apparatus forms an image including contents which are prepared by a computer program and prints on a recording medium. Specifically, the image forming apparatus scans light on the photoconductor to form an electrostatic latent image thereon, and develops the formed electrostatic latent image with a developer, and then forms an image by transferring the developed electrostatic latent image into a paper and fixing it thereon.

FIG. 1 is a view illustrating a transferring process of a conventional image forming apparatus. As shown in FIG. 1, the conventional image forming apparatus 1 includes a photoconductor 2, a charging part 3 that charges the photoconductor 2, a developing part 4 that applies a developer on the charged photoconductor 2, a transferring part 5 that transfers an image formed on the photoconductor 2 onto a recording medium, and a static electricity erasing part 7 that erases a surface potential of the photoconductor 2.

In the conventional image forming apparatus 1, the photoconductor 2 is charged to about −600 V by a voltage applied to the charging part 3, and when a surface of the charged photoconductor 2 is exposed, the exposed surface of the photoconductor 2 has a voltage of about −70[[˜]] to about −100 V. At this time, when a voltage of −500 V is applied to the developing part 4, an image is formed on the exposed surface of the photoconductor 2 by a potential difference between the developing part 4 and the photoconductor 2. Thus, the image formed on the photoconductor 2 is transferred onto the recording medium by the transferring part 5.

A charging potential according to the voltage applied to the charging part 3, an exposure potential of the exposed surface of the photoconductor 2, and the voltage applied by the developing part 4 have to be properly controlled in order to transfer the image formed on the photoconductor 2 onto the recording medium uniformly.

However, if the developing part 4 is not properly mounted in the image forming apparatus 1, the surface of the photoconductor 2 is not properly charged. The improper charge of the photoconductor 2 may cause a problem in that the carrier of the developer containing the carrier and toner is developed on the photoconductor 2, and power is not applied to the developing part 4, Thus, a problem arises because an abnormal image is formed on the photoconductor 2.

To overcome these problems, the conventional image forming apparatus 1 determines a mount state of the developing part 4 by measuring intensity of current detected according to the power applied to the developing part 4. However, even in this case, since only the intensity of current flowing through a plurality of developing parts 4 may be known, it is difficult to know which of the plurality of developing parts 4 is properly mounted.

### SUMMARY OF THE INVENTION

The present general inventive concept to provides an image forming apparatus which is capable of determining a mount state of each of a plurality of developing parts by controlling to switch the operation of static electricity erasing parts to erase a surface potential of a photoconductor and the operation of transferring parts to transfer an image onto a recording medium, and a power supplying method thereof.

Additional aspects and utilities of the present general inventive concept will be set forth in part in the description which follows and, in part, will be obvious from the description, or may be learned by practice of the present general inventive concept.

The foregoing and/or other aspects of the present general inventive concept can be achieved by providing an image forming apparatus comprising an image forming part that forms an image on a recording medium and comprises a plurality of photoconductors, a plurality of charging parts that charges the photoconductors, a plurality of developing parts that develops the charged photoconductors, and a plurality of static electricity erasing parts that erases surface potentials of the charged photoconductors, a power supplying part that supplies power to the image forming part, and a controller that controls to switch the operation of the plurality of static electricity erasing parts independently from each other and controls the image forming part to form the image on the recording medium if power applied to the respective plurality photoconductors through the plurality of charging parts and the plurality of developing parts reaches a target value.

The image forming apparatus may further include a notifying part, wherein, if the power applied to the plurality of photoconductors is smaller than the target value, the controller controls to notify a user through the notifying part of mount states of the plurality of developing parts corresponding to the plurality of photoconductors to which the power smaller than the target value is applied.

The image forming apparatus may further include a plurality of transferring parts that transfer the images formed on the plurality of photoconductors onto the recording medium, wherein the controller controls to switch the operation of the plurality of transferring parts independently from each other, and controls the image forming part to form the image on the recording medium if the power applied to the plurality of photoconductors reaches the target value.

The controller may control to sequentially switch the operation of at least one of the plurality of static electricity erasing parts and the transferring parts.

The controller may control power supplying part to apply power of the same magnitude to the plurality of photoconductors.

The image forming apparatus may further include a voltage/current detecting part that detects a voltage or current applied to the plurality of photoconductors according to the power supply, wherein the controller controls to detect the power applied to the plurality of photoconductors through the voltage/current detecting part.

The foregoing and/or other aspects of the general inventive concept can also be achieved by providing an image forming apparatus comprising an image forming part that forms an image on a recording medium and comprises a plurality of photoconductors, a plurality of charging parts that charges the photoconductors, a plurality of developing parts that develops the charged photoconductors, and a plurality of transferring parts that transfers the image formed on the photoconductors onto the recording medium, a power supplying part that supplies power to the image forming part, and a controller that controls to switch the operation of the plurality of transferring parts independently from each other, and controls the image forming part to form the image on the recording medium if power applied to the plurality of photoconductors through the plurality of charging parts and the plurality of developing parts reaches a target value.

The image forming apparatus may further include a notifying part, wherein, if the power applied to the plurality of photoconductors is smaller than the target value, the controller controls to notify a user through the notifying part of mount states of the plurality of developing parts corresponding to the plurality of photoconductors to which the power smaller than the target value is applied.

The controller may control to sequentially switch the operation of the plurality of transferring parts.

The controller may control the power supplying part to apply power of the same magnitude to the plurality of photoconductors.

The image forming apparatus may further include a voltage/current detecting part that detects a voltage or current applied to the plurality of photoconductors according to the power supply, wherein the controller controls to detect the power applied to the plurality of photoconductors through the voltage/current detecting part.

The foregoing and/or other aspects of the general inventive concept can also be achieved by providing a power supplying method of an image forming apparatus including an image forming part that forms an image on a recording medium and comprises a plurality of photoconductors, a plurality of charging parts that charges the photoconductors, a plurality of developing parts that develops the charged photoconductors, and a plurality of static electricity erasing parts that erases surface potentials of the charged photoconductors, the power supplying method comprising applying power to the plurality of photoconductors through the plurality of charging parts and the plurality of developing parts, switching the operation of the plurality of static electricity erasing parts independently from each other, detecting the power applied to the plurality of photoconductors through the switching, determining whether the detected power reaches a target value, and forming the image on the recording medium if the detected power reaches the target value.

The determining of whether the detected power reaches the target value may include, if the power applied to the plurality of photoconductors is smaller than the target value, notifying a user of mount states of the plurality of developing parts corresponding to the plurality of photoconductors to which the power smaller than the target value is applied.

The switching of the operation of the plurality of static electricity erasing parts independently from each other may include sequentially switching the operation of the static electricity erasing parts.

The applying power to the photoconductors may include applying the power of the same magnitude to the plurality of photoconductors.

The foregoing and/or other aspects of the general inventive concept can also be achieved by providing a power supplying method of an image forming apparatus including an image forming part that forms an image on a recording medium and comprises a plurality of photoconductors, a plurality of charging parts that charges the photoconductors, a plurality of developing parts that develops the charged photoconductors, and a plurality of transferring parts that transfers the image formed on the of the charged photoconductors onto the recording medium, the power supplying method comprising switching the operation of the transferring parts independently from each other, detecting power applied to the plurality of photoconductors through the switching, determining whether the detected power reaches a target value, and forming the image on the recording medium if the detected power reaches the target value.

The determining of whether the detected power reaches the target value may include, if the power applied to the plurality of photoconductors is smaller than the target value, notifying a user of mount states of the plurality of developing parts corresponding to the plurality of photoconductors to which the power smaller than the target value is applied.

The switching of the operation of the plurality of transferring parts independently may include sequentially switching the operation of the plurality of transferring parts.

The applying power to the plurality of photoconductors may include applying the power of the same magnitude to the plurality of photoconductors.

The foregoing and/or other aspects of the general inventive concept can also be achieved by providing an image forming apparatus comprising an image forming part that forms an image on a recording medium and comprises a plurality of photoconductors, a plurality of charging parts that charges the photoconductors, a plurality of developing parts, and a plurality of static electricity parts that erases surface potentials of the charged plurality of photoconductors; and a controller that independently controls an operation of the plurality of static electricity erasing parts independently from each other, and controls an operation of the transferring parts independently from each other.

The foregoing and/or other aspects of the general inventive concept can also be achieved by providing an image forming apparatus comprising a first image forming apparatus having a first photoconductor and a first static electricity erasing part, a second image forming apparatus having a second photoconductor and a second static electricity erasing part; and a controller to control the first image forming apparatus and the second image forming apparatus according to first and second power applied corresponding to the first photoconductor and the second photoconductor.

The foregoing and/or other aspects of the general inventive concept can also be achieved by providing an image forming part that comprises a photoconductor, a charging part, a detecting part, and an erasing part, to form an image on a recording medium, and a controller to control the erasing part to be turned on and off according to power applied to the photoconductor independently from operations of the photoconductor, the charging part, and the detecting part.

The foregoing and/or other aspects of the general inventive concept can also be achieved by providing an image forming part that forms an image on a recording medium and comprises a plurality of photoconductors, and a plurality of static electricity erasing parts that erases surface potentials of the respective photoconductors, and a controller that independently controls operations of the respective static electricity erasing parts according to powers applied to corresponding ones of the photoconductors.

The image forming apparatus may further include the plurality of photoconductors comprising first and second photoconductors, the plurality of static electricity erasing parts comprising first and second static electricity erasing parts, the powers comprising a first power applied to the first photoconductor and a second power applied to the second photoconductor, and the controller controls the first static electricity erasing part according to the first power and the second static electricity erasing part according to the second power.

### BRIEF DESCRIPTION OF THE DRAWINGS

The above and/or other aspects and utilities of the present general inventive concept will become apparent and more readily appreciated from the following description of the exemplary embodiments, taken in conjunction with the accompanying drawings, in which:

FIG. 1 is a view illustrating a configuration of a conventional image forming apparatus;

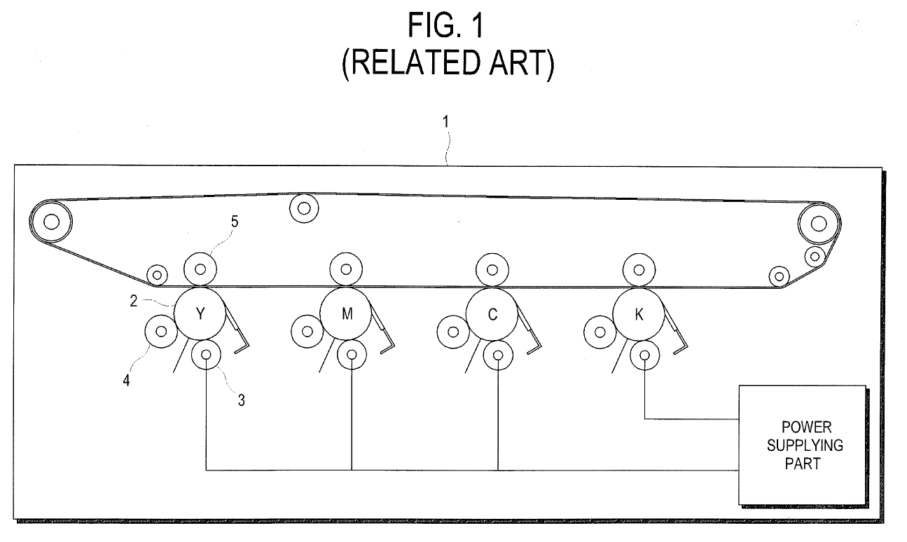

FIG. 2 is a block diagram illustrating a configuration of an image forming apparatus according to an exemplary embodiment of the present general inventive concept; and

FIG. 3 is a flow chart illustrating a power supplying method of the image forming apparatus according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings. The embodiments are described below so as to explain the present general inventive concept by referring to the figures.

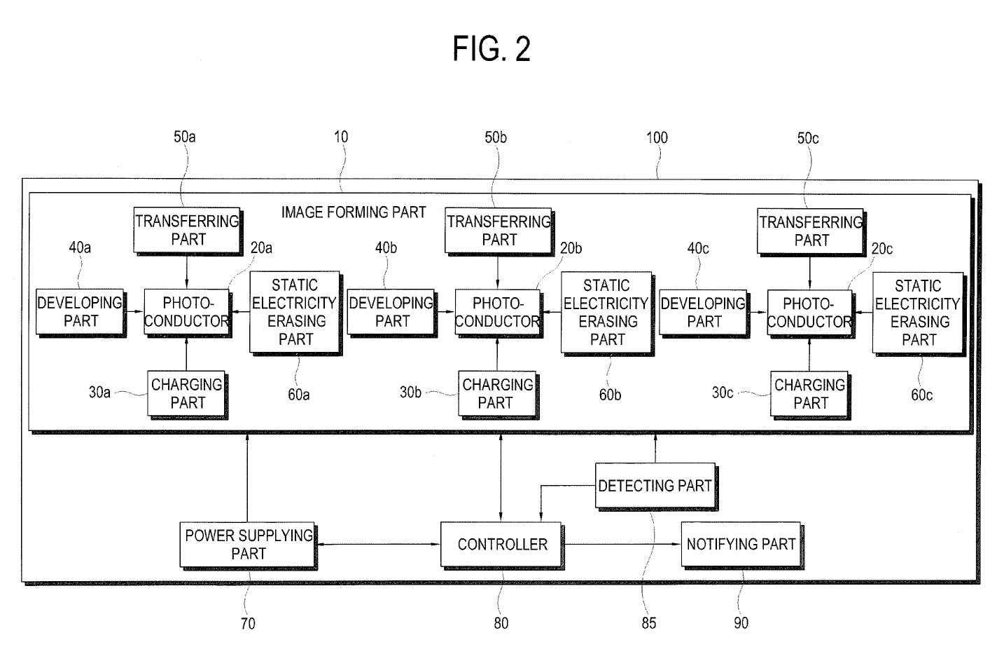

FIG. 2 is a block diagram illustrating a configuration of an image forming apparatus 100 according to an exemplary embodiment of the present general inventive concept. As illustrated in FIG. 2, the image forming apparatus 100 includes an image forming part 10, a power supplying part 70, a controller 80 and a notifying part 90. In this embodiment, the image forming apparatus 100 may be embodied by a printer that forms an image of colors corresponding to CMYK, i.e., cyan, magenta, yellow and black.

Although FIG. 2 illustrates three image forming parts in the image forming part 10, the present general inventive concept is not limited thereto. The number of the image forming parts can be more than three. The image forming part 10 forms an image on a recording medium and includes a photoconductor 20, a charging part 30, a developing part 40, a transferring part 50, and a static electricity erasing part 60. The photoconductor 20 forms an electrostatic latent image, and the charging part 30 includes a charging roller (not shown) that charges the photoconductor 20.

The photoconductor 20 may include photoconductors 20a, 20b, and 20c. The charging part may include charging parts 30a, 30b, and 30c to correspond to respective photoconductors 20a, 20b, and 20c. The developing part 40 may include developing parts 40a, 40b, and 40c. The transferring part 50 may include transferring parts 50a, 50b, and 50c. The static electricity erasing part 60 may include static electricity erasing parts 60a, 60b, and 60c.

The developing part 40 includes a developing roller (not illustrated) that applies a developer on the photoconductor 20 charged by the charging part 30. In this embodiment, the image forming apparatus 100 is provided with a mounting part (not illustrated) on which the developing part 40 is detachably mounted.

In FIG. 2, the transferring part 50 includes a transferring roller (not illustrated) that transfers the image formed on the photoconductor 20 into a recording medium. The static electricity erasing part 60 erases a surface potential of the charged photoconductor 20. The static electricity erasing part 60 is provided in plural numbers corresponding to the number of photoconductors 20 and may be embodied by a lamp or the like to erase the surface potential.

The power supplying part 70 supplies power to the image forming part 10 to form an image on the recording medium. More specifically, the power supplying part 70 supplies charging power to charge the photoconductor 20, developing power to develop the charged photoconductor 20, and transferring power to transfer an image onto the recording medium.

In FIG. 2, the controller 80 controls to switch the operation of the static electricity erasing part 60 independently and controls the image forming part 10 to form the image on the recording medium if the power applied to each of the photoconductors 20a, 20b, and 20c by the charging part 30 and the developing part 40 reaches a target value.

The controller 80 may control the static electricity erasing part 60 to be turned on and off a predetermined time before or after operation of the photoconductors 20. However, the controller 80 may independently control the static electricity erasing part 60 from operation of the transferring part 50 by controlling according to detected voltage and/or current.

First, the controller 80 controls the power supplying part 70 to supply the power to the charging part 30 and the developing part 40. Then, the controller 80 detects a voltage and/or current generated due to a potential difference between when the surface potential of the charged photoconductor 20 is erased by switching-on of the static electricity erasing part 60 and when the surface potential of the charged photoconductor 20 is not erased by switching-off of the static electricity erasing part 60.

In this present embodiment, the voltage and/or current may be detected by a voltage and/or current detecting part 85 configured by a circuit to feedback detected voltage and/or current to the power supplying part 70. The detecting part 85 may be a voltage and/or current detecting part. The detecting part 85 may include a plurality of detecting parts to correspond to respective image forming parts, and the detecting parts are independently controlled by the controller 80 to be independently turned on and off according to the independently detected voltage and/or current from the respective image forming parts.

If the developing part 40 is properly mounted in the image forming apparatus 100, a voltage of about −500 V is applied from the developing part 40 to the photoconductor 20. On the other hand, if the developing part 40 is not properly mounted in the image forming apparatus 100, the voltage applied to the photoconductor 20 becomes reduced. The potential difference between properly mounted developing parts 40a, 40b, and 40c and improperly mounted developing parts 40a, 40b, and 40c is detected by the controller 80.

Accordingly, the controller 80 includes voltage/current detecting part and controls it to detect sequentially the current flowing due to a potential difference while switching each operation of static electricity erasing parts 60a, 60b, and 60c independently.

For example, assuming that currents detected when the developing parts 40a, 40b, and 40c are properly mounted in the image forming apparatus 100 are 20 μA each, respectively, then the total detected current is 60 μA.

In this present embodiment, when the controller 80 turns off the operation of one of the static electricity erasing parts (e.g., 60a) corresponding to any one (e.g., 20a) of the plurality of photoconductors 20a, 20b and 20c, a surface potential of the corresponding photoconductor is not erased, and accordingly, charging current becomes very small. Accordingly, the total current flowing through the developing parts 40a, 40b, and 40c is generally detected to be about 40 μA.

However, if the developing part 40a is not properly mounted in the image forming apparatus 100 and the detected current is smaller than 20 μA, then the reduction amount of the total current flowing through the developing parts 40a, 40b and 40c is also smaller than 20 μA. Thus, the controller 80 can detect the developing part 40a of the plurality of developing parts 40, which is not properly mounted in the image forming apparatus 100, based on the total current detected when the controller 80 turns on/off each operation of the static electricity erasing parts 60a, 60b, and 60c, which correspond to the photoconductors 20a, 20b, and 20c, independently of each other.

In this present embodiment, the controller 80 may sequentially turn on and off the operation of each of the static electricity erasing parts 60a, 60b, and 60c corresponding to the photoconductors 20a, 20b, and 20c.

According to the present embodiment, controller 80 can turn off each operation of the static electricity erasing parts 60b and 60c corresponding to the photoconductors 20b and 20c of the plurality of photoconductors 20a, 20b, and 20c, and measures the reduction amount of the total current flowing through the plurality of photoconductors 20a, 20b, and 20c to determine whether or not the developing parts 40b and 40c are properly mounted in the image forming apparatus 100.

Thus, the controller 80 controls the image forming apparatus 100 to form an image only when all the developing parts 40a, 40b, and 40c are properly mounted in the image forming apparatus 100, thereby reducing toner waste and improving the quality of a print image.

On the other hand, there are some cases where the plurality of static electricity erasing parts 60 have to be operated collectively, but not independently corresponding to the photoconductors 20. In these cases, the controller 80 detects the transferring power applied to the photoconductors 20a, 20b, and 20c by switching on the operation of the transferring parts 50 independently, and controls the image forming part 10 to form an image on the recording medium when the detected power reaches a target value. This occurs because the transferring parts 50 can erase the surface potential of the photoconductors 20 similar to the static electricity erasing parts 60. Thus, the controller can determine the mount states of the developing parts based upon the detection of the target value of the transferring power.

Thus, in this present exemplary embodiment of FIG. 2, the image forming apparatus 100 can detect the mount state of the developing parts 40 without difficulty and will not allow the image to be formed if any of the developing parts 40 is not properly mounted in the image forming apparatus 100, thereby forming a correct image as well as preventing waste of toner.

In this exemplary embodiment, the image forming apparatus 100 may further include the notifying part 90. The notifying part 90 notifies a user which of the plurality of developing parts 40a, 40b and 40c is not properly mounted in the image forming apparatus 100, under control of the controller 80.

Also, the notifying part 90 may be embodied by a display unit such as a light emitting diode (LED), a liquid crystal display (LCD) panel or others known in the art, but is not particularly limited as long as it may notify the user, for example, of a sound output part that outputs a sound signal to the user.

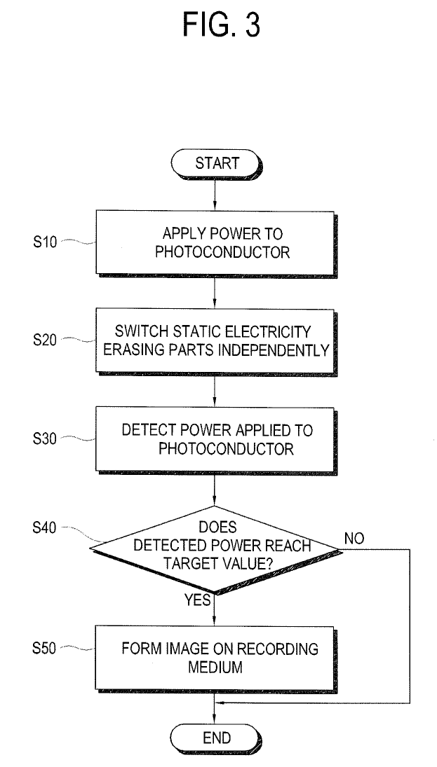

Hereinafter, a power supplying method of the image forming apparatus 100 according to an exemplary embodiment of the present invention will be described with reference to FIG. 3.

First, in FIG. 3, the controller 80 controls the power supplying part 70 to apply power to the photoconductors 20 through the charging parts 30 and the developing parts 40 at operation S10. Then, the controller 80 controls to switch the operation of the static electricity erasing parts 60, which erase the surface potential of the photoconductors 20, independently at operation S20.

In this exemplary embodiment, the controller 80 may alternatively provide control to switch the operation of the transferring parts 50 instead of the static electricity erasing parts 60.

Next, at operation S30, the controller 80 includes control to detect the power applied to the photoconductors 20a, 20b, and 20c through the switching at the operation S20.

Then, the controller 80 includes control to determine whether or not the power detected at the operation S30 reaches a target value at operation S40. If the controller 80 determines that the power detected at the operation S30 does not reach the target value, an operation of notifying the mount state of the developing parts 40 may be further included to allow a user to grasp the mount state of the developing parts 40a, 40b, and 40c without difficulty.

On the other hand, as illustrated in FIG. 3, if the controller 80 determines that the power detected at the operation S30 reaches the target value at operation S40, then the controller 80 controls the image forming part 10 to form an image on the recording medium at operation S50.

Finally, if the controller 80 determines that the power detected at the operation S30 reaches the target value in operation S40, then the image is formed on the recording medium at operation S50.

As apparent from the above description, the present invention provides an image forming apparatus which is capable of grasping a mount state of each of a plurality of developing parts by switching-on the operation of static electricity erasing parts and the operation of transferring parts to erase a surface potential of photoconductors, and a power supplying method thereof.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

In addition, the present general inventive concept provides an image forming apparatus which is capable of reducing waste of toner and improving quality of a print image by allowing the image forming apparatus to form an image only when all the developing parts are properly mounted in the image forming apparatus 100, and a power supplying method thereof.

Although a few exemplary embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus comprising:
an image forming part that forms an image on a recording medium and comprises a photoconductor, a charging part that charges the photoconductor, a developing part that develops the charged photoconductor, and a static electricity erasing part that erases a surface potential of the charged photoconductor;
a power supplying part that supplies power to the image forming part; and
a controller that controls to switch an operation of the static electricity erasing part, and controls the image forming part to form the image on the recording medium if power applied to the photoconductor through the charging part and the developing part reaches a target value.

2. The image forming apparatus according to claim 1, further comprising:
a notifying part,
wherein if the power applied to the photoconductor is smaller than the target value, the controller controls to notify a user through the notifying part of a mount state of the developing part corresponding to the photoconductors to which the power smaller than the target value is applied.

3. The image forming apparatus according to claim 1, wherein the photoconductor, the charging part, the developing part, and the static electricity erasing part comprise a plurality of photoconductors, a plurality of charging parts, a plurality of developing parts and a plurality of static electricity erasing parts, respectively, and the controller controls to switch an operation of the plurality of static electricity erasing parts independently from each other.

4. The image forming apparatus according to claim 3, further comprising:
a plurality of transferring parts that transfer the images formed on the plurality of photoconductors onto the recording medium,
wherein the controller controls to switch the operation of the plurality of transferring parts independently from each other, and controls the image forming part to form the image on the recording medium if the power applied to the plurality of photoconductors reaches the target value.

5. The image forming apparatus according to claim 3, wherein the controller controls to sequentially switch the operation of the plurality of static electricity erasing parts.

6. The image forming apparatus according to claim 3, wherein the controller controls the power supplying part to apply power of the same magnitude to the plurality of photoconductors.

7. The image forming apparatus according to claim 1, further comprising:
a voltage/current detecting part that detects a voltage or current applied to the photoconductor according to the power supply,
wherein the controller controls to detect the power applied to the photoconductor through the voltage/current detecting part.

8. An image forming apparatus comprising:
an image forming part that forms an image on a recording medium and comprises a photoconductor, a control part that charges the photoconductor, a developing part that develops the charged photoconductor, and a transfer part that transfers the image formed on the photoconductor onto the recording medium;
a power supplying part that supplies power to the image forming part; and
a controller that controls to switch the operation of the transferring part, and controls the image forming part to form the image on the recording medium if power applied to the photoconductor through the charging part and the developing part reaches a target value.

9. The image forming apparatus according to claim 8, further comprising:
a notifying part,
wherein if the power applied to the photoconductor is smaller than the target value, the controller controls to notify a user through the notifying part of a mount state of the developing part corresponding to the photoconductor to which the power smaller than the target value is applied.

10. The image forming apparatus according to claim 8, wherein the photoconductor, the charging part, the developing part, and the static electricity erasing part comprise a plurality of photoconductors, a plurality of charging parts, a plurality of developing parts and a plurality of static electricity erasing parts, respectively, and the controller controls to switch an operation of the plurality of static electricity erasing parts independently from each other.

11. The image forming apparatus according to claim 10, wherein the controller controls to sequentially switch the operation of the plurality of transferring parts.

12. The image forming apparatus according to claim 10, wherein the controller controls the power supplying part to apply power of the same magnitude to the plurality of photoconductors.

13. The image forming apparatus according to claim 10, further comprising:
a voltage/current detecting part that detects a voltage or current applied to the plurality of photoconductors according to the power supply,
wherein the controller controls to detect the power applied to the plurality of photoconductors through the voltage/current detecting part.

14. A power supplying method of an image forming apparatus including an image forming part that forms an image on a recording medium and comprises a photoconductor, a charging part that charges the photoconductor, a developing part that develops the charged photoconductor, and a static electricity erasing part that erases a surface potential of the charged photoconductor, the power supplying method comprising:
applying power to the photoconductor through the charging part and the developing part;
switching the operation of the static electricity erasing part;
detecting the power applied to the photoconductor through the switching;
determining whether the detected power reaches a target value; and
forming the image on the recording medium if the detected power reaches the target value.

15. The power supplying method according to claim 14, wherein the determining of whether the detected power reaches the target value comprises:
if the power applied to the photoconductor is smaller than the target value, notifying a user of a mount state of the developing part corresponding to the photoconductor to which the power smaller than the target value is applied.

16. The power supplying method according to claim 14, wherein the photoconductor, the charging part, the developing part, and the static electricity erasing part comprise a plurality of photoconductors, a plurality of charging parts, a plurality of developing parts and a plurality of static electricity erasing parts, respectively, and the switching the operation of the static electricity erasing part comprises switching the operation of the plurality of static electricity erasing parts independently from each other.

17. The power supplying method according to claim 16, wherein the switching the operation of the plurality of static electricity erasing parts independently from each other comprises sequentially switching the operation of the plurality of static electricity erasing parts.

18. The power supplying method according to claim 14, wherein the photoconductor, the charging part, the developing part, and the static electricity erasing part comprise a plurality of photoconductors, a plurality of charging parts, a plurality of developing parts and a plurality of static electricity erasing parts, respectively, and the applying of power to the plurality of photoconductors comprises:
applying the power of the same magnitude to the plurality of photoconductors.

19. A power supplying method of an image forming apparatus including an image forming part that forms an image on a recording medium and comprises a photoconductor, a charging part that charges the photoconductor, a developing part that develops the charged photoconductor, and a transferring part that transfers the image formed on the charged photoconductor onto the recording medium, the power supplying method comprising:
switching the operation of the transferring part;
detecting power applied to the photoconductor through the switching;
determining whether the detected power reaches a target value; and
forming the image on the recording medium if the detected power reaches the target value.

20. The power supplying method according to claim 19, wherein the determining of whether the detected power reaches the target value comprises, if the power applied to the photoconductor is smaller than the target value, notifying a user of a mount state of the developing part corresponding to the photoconductor to which the power smaller than the target value is applied.

21. The power supplying method according to claim 19, wherein the photoconductor, the charging part, the developing part, and the static electricity erasing part comprise a plurality of photoconductors, a plurality of charging parts, a plurality of developing parts and a plurality of static electricity erasing parts, respectively, and the switching of the operation of the transferring part comprises switching the operation of the plurality of transferring parts independently of each other.

22. The power supplying method according to claim 21, wherein the switching the operation of the plurality of transferring parts independently of each other comprises sequentially switching the operation of the plurality of transferring parts.

23. The power supplying method according to claim 19, wherein the photoconductor, the charging part, the developing part, and the static electricity erasing part comprise a plurality of photoconductors, a plurality of charging parts, a plurality of developing parts and a plurality of static electricity erasing parts, respectively, and the applying power to the photoconductor comprises applying the power of the same magnitude to the plurality of photoconductors.

24. An image forming apparatus comprising:
an image forming part that forms an image on a recording medium and comprises a plurality of photoconductors, a plurality of charging parts that charges the photoconductors, a plurality of developing parts, a plurality of transferring parts, and a plurality of static electricity parts that erases surface potentials of the charged plurality of photoconductors; and
a controller that independently controls an operation of the plurality of static electricity erasing parts independently from each other, and controls an operation of the transferring parts independently from each other.

25. An image forming apparatus comprising:
a first image forming apparatus having a first photoconductor and a first static electricity erasing part;
a second image forming apparatus having a second photoconductor and a second static electricity erasing part; and
a controller to control the first image forming apparatus and the second image forming apparatus according to first and second power applied corresponding to the first photoconductor and the second photoconductor.

26. An image forming apparatus comprising:
an image forming part that comprises a photoconductor, a charging part, a detecting part, and an erasing part, to form an image on a recording medium; and
a controller to control the erasing part to be turned on and off according to power applied to the photoconductor independently from operations of the photoconductor, the charging part, and the detecting part.

27. An image forming apparatus comprising:
an image forming part that forms an image on a recording medium and comprises a plurality of photoconductors, and a plurality of static electricity erasing parts that erases surface potentials of the respective photoconductors; and
a controller that independently controls operations of the respective static electricity erasing parts according to power applied to corresponding ones of the photoconductors.

28. The image forming apparatus according to claim 27, wherein:
the plurality of photoconductors comprises first and second photoconductors;
the plurality of static electricity erasing parts comprises first and second static electricity erasing parts;
the power comprises a first power applied to the first photoconductor and a second power applied to the second photoconductor; and
the controller controls the first static electricity erasing part according to the first applied power and the second static electricity erasing part according to the second applied power.
